(19) United States
(12) Patent Application Publication
(10) Pub. No.: US 2001/0046346 A1
(43) Pub. Date: Nov. 29, 2001

(54) MICROMACHINED STRUCTURE FOR OPTO-MECHANICAL MICRO-SWITCH

(76) Inventor: BRENT E. BURNS, RANCHO PALOS VERDES, CA (US)

Correspondence Address: BEVER HOFFMAN & HARMS, LLP, 2099 GATEWAY PLACE, SUITE 320, SAN JOSE, CA, 951101017

(21) Appl. No.: 09/366,428

(22) Filed: Aug. 2, 1999

(51) Int. Cl. G02B 6/35

(52) U.S. Cl. 385/18; 359/872; 216/24

(57) ABSTRACT

An opto-mechanical micro-switch has a micromachined structure fabricated from a single silicon substrate. The micromachined structure includes an inner frame connected by a pair of beams to an outer frame. The beams define an axis of rotation around which the inner frame rotates relative to the outer frame. Flat walls are formed on the inner frame by an anisotropic etching process. When the inner frame rotates relative to the outer frame, the flat wall pivots into a vertical position to reflect or impede light passing from a light source to a light receiver. During fabrication, etch-stop material is selectively deposited in predefined regions of the single silicon substrate, and then a masking layer is formed and patterned. The anisotropic etching process is then performed through openings in the masking layer to form the inner frame and the outer frame. The etch-stop material prevents etching in the predefined regions that are located between the inner and outer frames, thereby forming the beams. In one embodiment, Permalloy regions are formed on the inner frame prior to the anisotropic etching process. These Permalloy regions are subsequently utilized as part of a drive motor to rotate the inner frame relative to the outer frame.

### FIELD OF USE

The present invention relates to a micromachined structure and to an opto-mechanical micromachined switch (micro-switch) incorporating the micromachined structure. This invention also relates to methods for fabricating the micromachined structure and opto-mechanical micro-switch.

### BACKGROUND ART

Opto-mechanical switches typically include a light source, a light receiver, and a movable light blocking/reflecting mechanism. The light blocking/reflecting mechanism typically includes a drive motor that is selectively actuated to move a blocking/reflecting member between two positions. In one type of opto-mechanical switch, light is transmitted directly from the light source to the light receiver (e.g., fibers with collimating lenses), and blocking member is selectively positioned between the light source and light receiver by the drive motor, thereby selectively preventing light from reaching the light receiver. In another type of opto-mechanical switch, light from the light source is reflected off of a mirror (reflecting) member to a first light receiver or transmitted to a second light receiver when the mirror is displaced from the light beam. The mirror member is selectively repositioned by the drive motor out of the light path, thereby preventing light from reaching the light receiver.

Mechanical micro-switches for switching electrical signals are fabricated using batch processes similar to those used for manufacturing microelectronic devices (e.g., integrated circuits). Mechanical micro-switches typically include two contacts respectively formed on two substrates that are separately micromachined and then assembled such that a small gap is provided between the two contacts. A drive motor is utilized to selectively open/close the gap between the two contacts, thereby turning on/off the micro-switch. In one type of mechanical micro-switch, the drive motor applies an electro-magnetic force that causes one substrates to bend toward/away from the other substrate, thereby selectively closing/opening the gap between the two contacts. In another type of mechanical micro-switch, a hinge is provided between the two substrates, and the drive motor causes the substrates to pivot around the hinge, thereby selectively closing/opening the gap between the two contacts.

It would be desirable to produce an extremely small opto-mechanical switch using the structures utilized in the conventional mechanical micro-switches, discussed above. However, these structures do not facilitate opto-mechanical micro-switch production because, in each instance, post-fabrication assembly is required. In particular, mirror-type opto-mechanical switches require precise positioning of the flat mirror surface to accurately reflect light to a light receiver. If conventional mechanical micro-switch structures were used to produce a mirror-type opto-mechanical micro-switch, then this precise positioning of the flat mirror surface would be difficult and expensive to achieve.

It would therefore be desirable to have an opto-mechanical micro-switch or micro-mirror assembly that has reliable durability, fatigue and deformation characteristics, has accurate operating characteristics, and which can be fabricated at low cost using batch manufacturing processes.

### SUMMARY

Accordingly, the present invention provides an opto-mechanical micro-switch that includes a micromachined structure fabricated from a monocrystalline silicon substrate by etching through the substrate to form an inner frame surrounded by an outer frame. Because the position of the inner frame relative to the outer frame is defined during the etching process, the need for post-fabrication alignment of the inner frame is eliminated, thereby reducing manufacturing costs over conventional micromachining techniques.

In accordance with an aspect of the present invention, the micromachined structure includes a pair of beams formed by the etching process that connect the inner frame to the outer frame. The beams extend across the gaps formed during the etching process, and are aligned to define an axis of rotation around which the inner frame is pivotable (rotatable) relative to the outer frame. In one embodiment, the beams are formed by diffusing an etch-stop material (e.g., boron) into predefined regions of the monocrystalline silicon substrate. These predefined regions are not removed during the etching process, thereby forming beams that extend between the inner and outer frames. Because the spacing between the inner frame and the outer frame is fixed by the beams during the etching process, post-fabrication assembly and alignment of the inner frame to the outer frame is not necessary, thereby minimizing manufacturing costs and facilitating batch manufacturing processes.

In accordance with another aspect of the present invention, the etching process is performed using an anisotropic etchant that produces a flat wall on the inner frame. The monocrystalline silicon substrate is formed such that the upper and lower surfaces lie in {100} planes of the substrate. The anisotropic etchant stops at the {111} plane of the monocrystalline silicon substrate, thereby producing the flat wall at a known angle (i.e., 54.7°) relative to the upper and lower surfaces of the substrate. When the micromachined structure is incorporated into an opto-mechanical micro-switch and the inner frame is rotated a predetermined amount relative to the outer frame, the flat wall is rotated into a raised position to selectively obstruct or reflect light passing from the light source to the light receiver of the opto-mechanical micro-switch. Because the flat wall is reliably formed at a known angle by the anisotropic etching process, the raised position of the flat wall after rotation is reliably predictable, thereby providing accurate operating characteristics of the opto-mechanical micro-switch without post-fabrication assembly and adjustment while minimizing fabrication costs and facilitating batch manufacturing processes.

The present invention will be more fully understood in light of the following detailed description taken together with the drawings.

### BRIEF DESCRIPTION OF THE DRAWINGS

FIG. 1(A) is a perspective view showing a micromachined structure fabricated in accordance with one embodiment of the invention.

FIGS. 1(B), 1(C) and 1(D) are cross-sectional views of the micromachined structure taken along lines 1B-1B, 1C-1C and 1D-1D, respectively, in FIG. 1(A).

FIGS. 2(A), 2(B) and 2(C) are cross-sectional side views of the micromachined structure taken along line 2-2 in FIG. 1(A).

FIGS. 3(A), 3(B) and 3(C) are plan and cross-sectional side views of an opto-mechanical micro-switch incorporating the micromachined structure shown in FIG. 1(A).

FIGS. 4(A) through 4(D) are plan and side sectional views illustrating a process of diffusing etch-stop material into a substrate during the fabrication of the micromachined structure.

FIGS. 5(A) and 5(B) are plan and side sectional views illustrating a process of forming a silicon nitride layer over the substrate.

FIGS. 6(A) through 6(D) are side sectional views illustrating a process of plating Permalloy onto the substrate.

FIGS. 7(A) and 7(B) are plan top and bottom views illustrating a process of patterning the silicon nitride layer to form a mask.

FIGS. 8(A) through 8(C) are sectional front views taken along lines 8-8 in FIGS. 7(A) and 7(B) illustrating an anisotropic etching process.

FIGS. 9(A) through 9(C) are sectional side views taken along lines 9-9 in FIGS. 7(A) and 7(B) illustrating the anisotropic etching process.

FIGS. 10(A) through 10(C) are sectional side views taken along lines 10-10 in FIGS. 7(A) and 7(B) illustrating the anisotropic etching process.

### DETAILED DESCRIPTION

The present invention is directed to a micromachined structure in which an inner frame is pivotably or rotatably connected to an outer frame by a pair of beams. The present invention is also directed to opto-mechanical micro-switches that incorporate the micromachined structure. Although the micromachined structure is described below as part of the opto-mechanical micro-switches, the micromachined structure may be used for other purposes. For example, the micromachined structure may be utilized as a scanning micromirror in a barcode scanner. Therefore, applications of the micromachined structure disclosed herein are not necessarily limited to opto-mechanical micro-switches.

Definitions

In the following description and appended claims, the term “micromachined structure” is limited to structures formed using micromachining techniques (i.e., batch processes similar to those used for manufacturing microelectronic devices).

In addition, in the following description and appended claims, the phrase “formed from a single substrate” is intended to mean that a single manufactured substrate is processed using micromachining techniques to form one or more structural parts. Similarly, the phrase “formed from a monocrystalline silicon substrate” is intended to mean that a single silicon crystal is processed using micromachining techniques (e.g., diffusing impurities into the monocrystalline silicon substrate and/or chemically etching the monocrystalline silicon substrate) to form one or more structural parts that comprise portions of the single silicon crystal.

Micromachined Structure

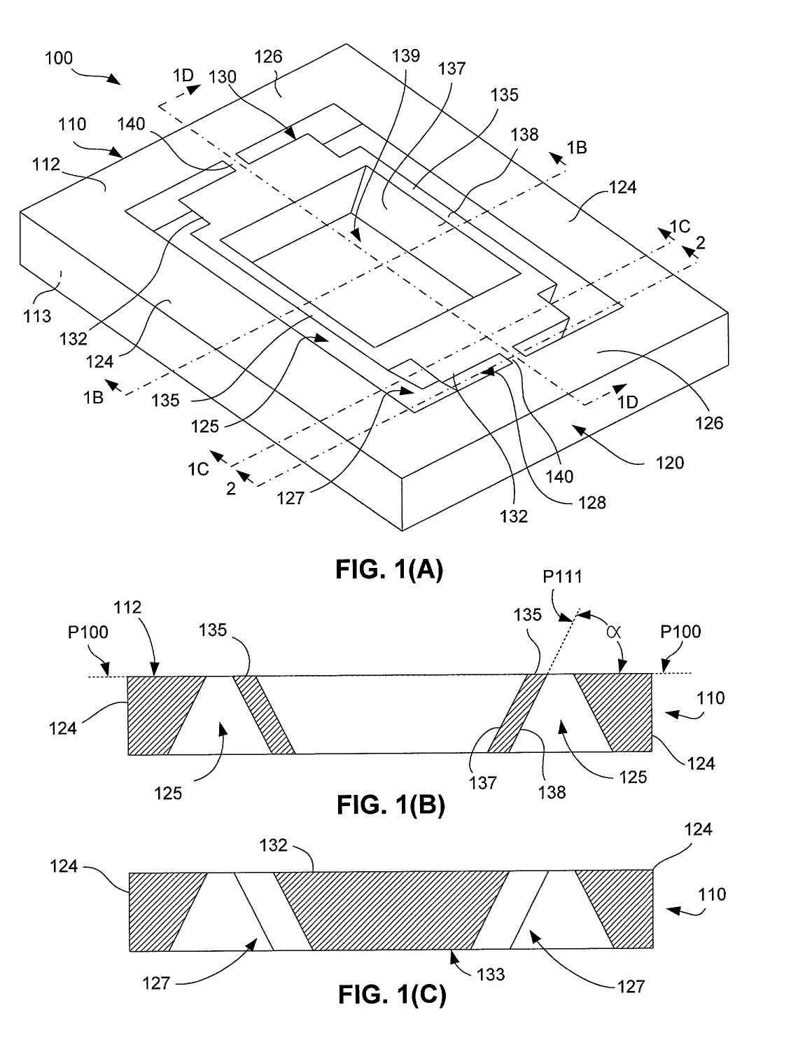

FIG. 1(A) is a perspective view showing a micromachined structure 100 that is formed from a single substrate 110. In accordance with an embodiment of the present invention, substrate 110 is a monocrystalline silicon substrate having an upper surface 112 and a lower surface 113 that lie in parallel {100} planes of monocrystalline silicon substrate 110. The single crystal structure of monocrystalline silicon substrate 110 provides mechanical advantages, such as superior stiffness, durability, fatigue and deformation characteristics. In addition, monocrystalline silicon substrates are inexpensive and readily available. Further, batch fabrication using monocrystalline silicon is well established. Therefore, monocrystalline silicon substrate 110 can be economically micromachined to form relatively defect-free micromachined structure 100. In other embodiments, substrate 110 may be formed using other materials.

Micromachined structure 100 includes an outer frame 120 and an inner frame 130 that are connected by a pair of beams 140. Outer frame 120 includes parallel side rails 124 and parallel end rails 126. Side rails 124 and end rails 126 are formed into a rectangular box-like shape that defines a central opening. Inner frame 130 is pivotally connected to outer frame 120 by beams 140, and is located in the central opening defined by side rails 124 and end rails 126 such that outer frame 120 completely surrounds inner frame 130. Inner frame 130 includes end pieces 132 and walls 135 that extend between end pieces 132 and surround (define) a center hole 139. Walls 135 are separated from side rails 124 of outer frame 120 by gaps 125, and have parallel inward-facing flat surfaces 137 and outward-facing flat surfaces 138. End pieces 132 are separated from side rails 124 by gaps 127 and from end rails 126 by gaps 128. As described below, one or both of inward-facing flat surface 137 and outward-facing flat surface 138 are utilized as light reflecting/blocking members that either reflect an incident light beam (i.e., when a light reflecting (mirror) material is formed on the relevant surface), or block the incident light beam (e.g., when the surface is partially or fully opaque).

FIGS. 1(B), 1(C) and 1(D) are cross-sectional views taken along lines 1B-1B, 1C-1C and 1D-1D, respectively, in FIG. 1(A).

FIG. 1(B) is a cross-sectional side view showing walls 135 and side rails 124 that are separated by gaps 125. The {100} plane of monocrystalline silicon substrate 110 defines upper surface 112. In addition, parallel inward-facing surface 137 and outward-facing surface 138 are defined by the {111} plane of monocrystalline silicon substrate 110. As is characteristic of a single silicon crystal, the {100} plane (indicated as horizontal (first) plane P100) intersects the {111} plane (indicated as second plane P111) at an angle a equal to 54.7°.

FIG. 1(C) is a side cross-sectional view showing end pieces 132 and side rails 124 that are separated by gaps 127. Gaps 127 are slightly wider than gaps 125 (see FIG. 1(B)) to reduce the mass of inner frame 130, thereby minimizing its rotational inertia. In addition, as described in detail below, end pieces 132 have lower surfaces 133 for supporting magnetic structures (not shown) that are utilized to pivot inner frame 130 around an axis of rotation defined by beams 140. Because of wide gaps 127, the width of lower surfaces 133 (measured along line 1C-1C; see FIG. 1(A)) is smaller than that of walls 135, thereby causing these magnetic structures to be located closer to the axis of rotation defined by beams 140.

FIG. 1(D) is a front cross-sectional view showing end pieces 132 and end rails 126 that are connected adjacent to upper surface 112, and are separated at lower surface 113 by gaps 128. FIG. 1(D) also indicates center hole 139, which provides inward-facing flat surfaces 137 that may be used as additional mirror surfaces, and further reduces the mass of inner frame 130, thereby further minimizing its rotational inertia. In an alternative embodiment, hole 139 may be omitted from inner frame 130.

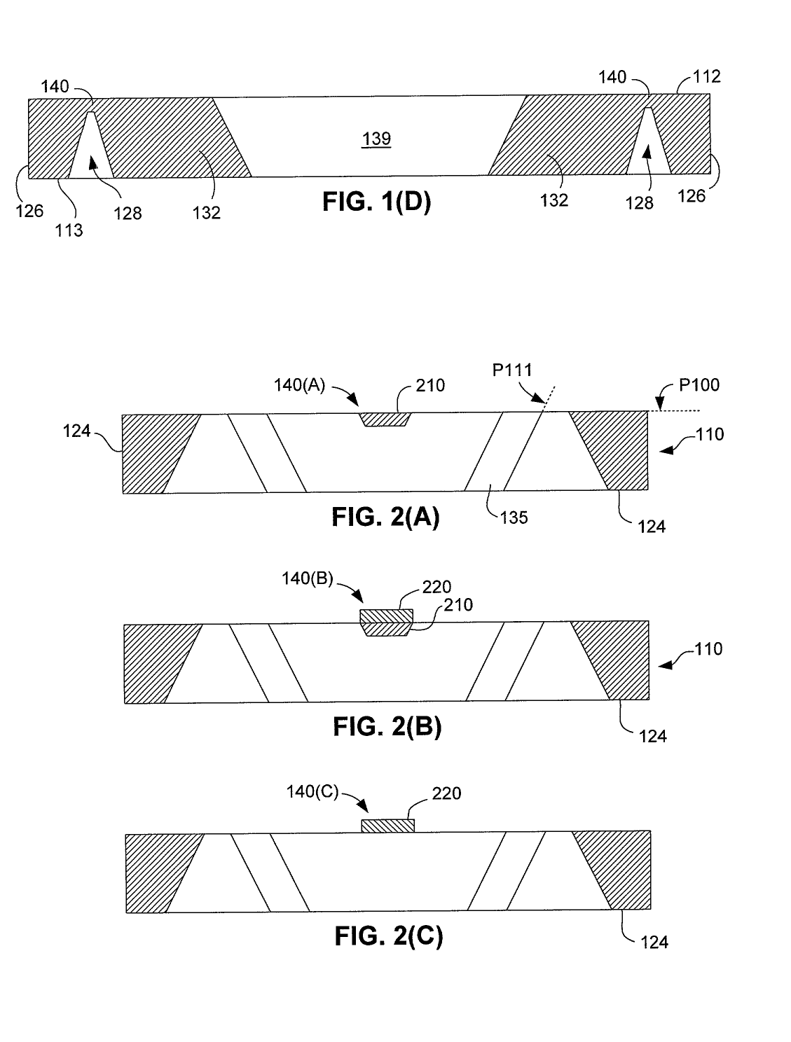

FIGS. 2(A), 2(B) and 2(C) are cross-sectional side views taken along line 2-2 in FIG. 1(A), and illustrate beams 140 (see FIG. 1(A)) according to three alternative embodiments of the present invention.

FIG. 2(A) shows a first embodiment in which a narrow portion 210 of monocrystalline silicon substrate 110 is utilized to form a beam 140(A) connected between the outer frame 120 and the inner frame 130. As indicated below, portion 210 is formed by diffusing an etch-stop material through upper surface 112 prior to the etching process utilized to form the gaps separating outer frame 120 and the inner frame 130. During the etching process, etching takes place in the undoped substrate material located adjacent to portion 210 to form a gap through which portion 210 extends, thereby forming beams 140(A).

FIG. 2(B) shows a second embodiment in which a beam 140(B) is formed by portion 210 (described above) and a flexible member 220 is deposited onto portion 210. Flexible member 220 may be formed from silicon nitride, which has intrinsic tensile stress that adds to the stress in portion 210 to reduce stretching when inner frame 130 is rotated relative to outer frame 120 and downward force is applied to inner frame 130. Other suitable materials may also be used in place of silicon nitride, such as thin film metals or other dielectric materials. Details regarding the formation of flexible member 220 are provided below.

FIG. 2(C) shows a beam 140(C) according to a third embodiment that only utilizes flexible member 220. As in the second embodiment, flexible member 220 may be formed from silicon nitride, or from another suitable material. By eliminating silicon portion 210 (see FIGS. 2(A) and 2(B)) from beam 140(C), the required etch-stop diffusion process may be eliminated from the fabrication process, thereby reducing manufacturing costs.

Opto-Mechanical Micro-Switch

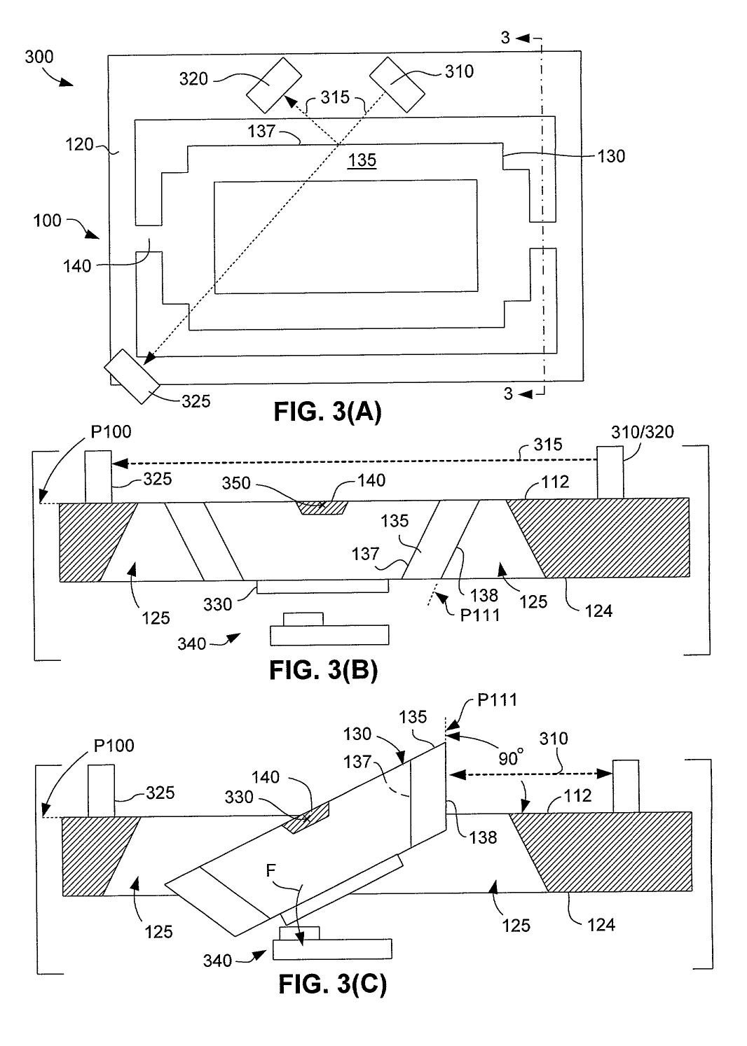

FIG. 3(A) is a plan top view showing a non-blocking opto-mechanical micro-switch 300 incorporating micromachined structure 100 according to an embodiment of the present invention. FIGS. 3(B) and 3(C) are sectional views taken along line 3-3 of FIG. 3(A), and show additional features of micro-switch 300.

Referring to FIG. 3(A), opto-mechanical micro-switch 300 includes a light source 310, a first light receiver 320, a second light receiver 325 and micromachined structure 100 either connected to or located adjacent to light source 310 and light receivers 320 and 325. In one embodiment, light source 310 and light receivers 320 and 325 are glass fibers with collimating lenses attached thereto. As indicated above, micromachined structure 100 includes an outer frame 120 and an inner frame 130 surrounded by and pivotally connected to the outer frame 120. Inner frame 130 including a wall 135 having a flat reflective surface 138 that is used to selectively reflect a light beam 315 from light source 310 to first light receiver 320.

FIGS. 3(B) and 3(C) are cross-sectional side views taken along line 3-3 in FIG. 3(A), and respectively show inner frame 130 in idle and pivoted positions relative to outer frame 120. As indicated in these figures, a drive motor is formed by a movable portion 330 attached to inner frame 130, and a stationary portion 340 connected, for example, to outer frame 120. Note that a longitudinal axis 350 (shown in end view) passes through and is defined by beams 140 about which inner frame 130 rotates relative to outer frame 120.

In accordance with the embodiment shown in FIGS. 3(A) through 3(C), inner frame 130 is selectively pivoted around axis 350 when a force F (e.g., electro-magnetic) is applied by the drive motor into a position in which the plane of the mirror is perpendicular to upper surface 112. In this manner, micromachined structure 100 facilitates operation of opto-mechanical micro-switch 300 by pivoting from a first position shown in FIG. 3(B), in which wall 135 is located below plane P100 defined by upper surface 112, to the upright (second) position shown in FIG. 3(C), the {111} plane P111 defining surface 138 intersects the {100} plane P100 of substrate 110 at an angle of approximately 90°. As indicated in FIG. 3(B), when inner frame 130 is in the first position, light beam 315 is transmitted across micromachined structure 100 to second light receiver 325, thereby indicating a first switch state. However, when rotated upward (FIG. 3(C)), light beam 315 is reflected by outer wall 138 back to first light receiver 320, thereby indicating a second switch state. Note in FIG. 3(C) that gaps 125 are large enough to allow free rotation of inner frame 130 relative to outer frame 120.

Although a single opto-mechanical micro-switch 300 is shown in FIGS. 3(A) through 3(C), the methods and structures of the present invention may be utilized to produce a multi-switch device including multiple micromachined structures 100 formed on a single substrate. Because micromachined structure 100 is formed using a batch process, multiple interacting micro-switches may be formed during the same fabrication process, thereby providing precise alignment of the mirror surfaces to produce a multi-switch arrangement.

Fabrication Process

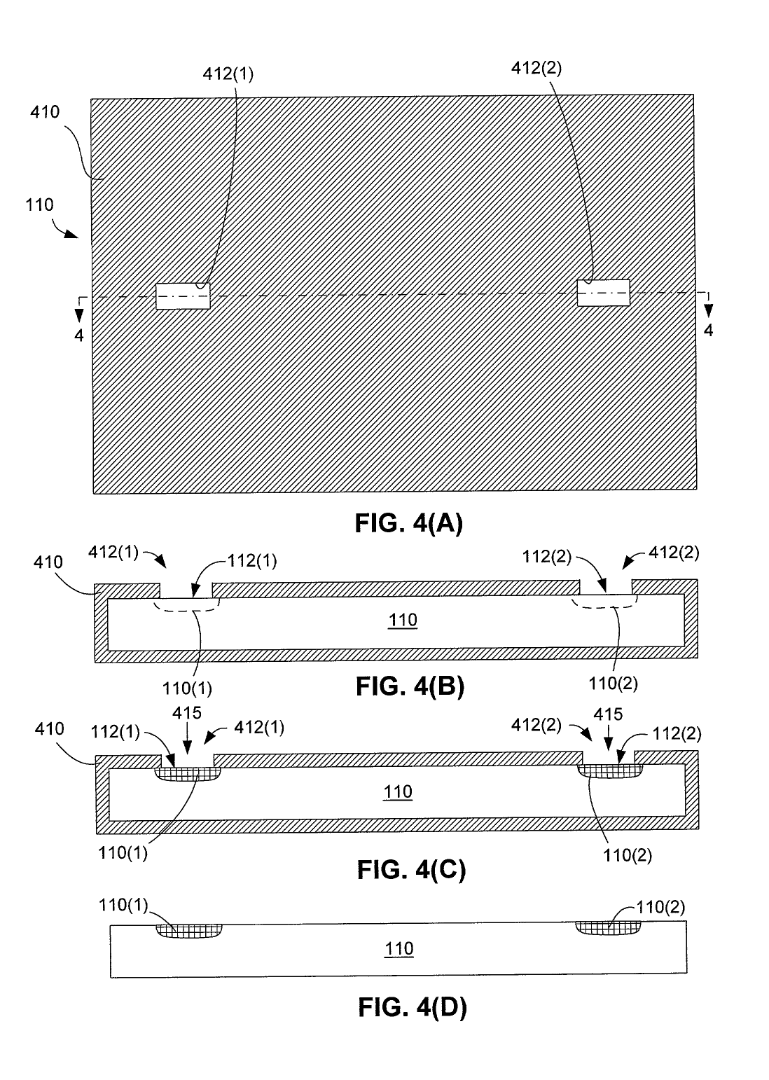

The starting material of micromachined structure 100 (shown in FIG. 1) is a single silicon crystal wafer (not shown) having a thickness of approximately 400 μm (i.e., in the range of 300 to 500 μm). In one embodiment, monocrystalline silicon substrate 110, which is used to form micromachined structure 100, is defined by a section of this single silicon crystal wafer that has a length (measured along line 4-4 of FIG. 4(A)) of approximately 7 millimeters, and a width (measured perpendicular to line 4-4) of approximately 5 millimeters. As mentioned above, the upper surface of substrate 110 is defined by the {100} plane of the single silicon crystal wafer (not shown). In an alternative embodiment, an additional silicon layer having a thickness in the range of 1 to 10 μm may be epitaxially deposited on the entire upper surface of substrate 110 to serve as an etch-stop layer.

Briefly summarized, the fabrication process begins with the formation of predefined etch-stop regions through the upper surface of substrate 110 that are used to form beams 140 (see FIG. 1(A)). Note that these etch-stop regions are not required when the embodiment shown in FIG. 2(C) is produced. Next, a silicon nitride layer is deposited on substrate 110. Optional Permalloy regions are then plated onto portions of the silicon nitride layer located on the lower surface of substrate 110. These Permalloy portions form part of a drive motor used in some opto-mechanical micro-switch embodiments to apply electromechanical torque to micromachined structure 100. The silicon nitride layer is patterned to form a mask used during the anisotropic etching process. Next, an anisotropic etching step is performed through openings formed in the silicon nitride layer to produce gaps 125, 127 and 128 that are located between inner frame 130 and outer frame 140 (see FIG. 1(A)). During the anisotropic etching process, the etch-stop regions (when used) prevent complete separation of inner frame 130 and outer frame 140. After the isotropic etching step, inner frame 130 is suspended from outer frame 120 by beams 140. Finally, optional polishing and coating steps are performed to provide light reflecting (mirror) surfaces on walls 135 of inner frame 130 (see FIG. 1(A)).

The fabrication process is now described in additional detail with reference to the figures.

1. Etch-Stop Diffusion

FIGS. 4(A) through 4(D) illustrate steps of forming predefined etch-stop regions in substrate 110 in accordance with one embodiment of the present invention. Formation of the etch-stop regions allows selective areas of substrate 110 to remain after large amounts of silicon have been etched away during the anisotropic etching process used to form gaps 125, 127 and 128 (see FIGS. 1(C), 1(D) and 1(E)). These etch-stop regions also eliminate the need for tight control on etch timing and allow for uniform thickness of remaining silicon areas despite variations in thickness across the wafer.

FIGS. 4(A) through 4(D) depict process steps associated with the formation of etch-stop regions in substrate 110 in accordance with an embodiment of the present invention. FIG. 4(A) is a plan top view, and FIGS. 4(B), 4(C) and 4(D) are sectional side views taken along line 4-4 in FIG. 4(A).

Referring to FIGS. 4(A) and 4(B), the process begins by depositing a masking layer 410 on upper surface 112 of substrate 110, and patterning masking layer 410 to provide rectangular openings 412(1) and 412(2) that expose surface portions 112(1) and 112(2) of upper surface 112. In one embodiment, masking layer 410 is silicon dioxide grown to a thickness of 1 to 2 μm. In another embodiment, masking layer 410 is silicon nitride deposited to a thickness of 0.2 to 0.5 μm. In yet another embodiment, masking layer 410 is a combination of silicon dioxide and silicon nitride. Masking layer 410 is patterned using known techniques to define openings 412(1) and 412(2) that have lengths (measured along line 4-4) of approximately 180 μm (i.e., such that the resulting etch-stop regions are approximately 20 to 40 μm longer than beam 140 (see FIG. 1(A)). As indicated in FIG. 4(B), upper surface portions 112(1) and 112(2) are respectively located over predefined regions 110(1) and 110(2) of substrate 110. As discussed below, after the etching step, predefined regions 110(1) and 110(2) form at least a portion of the beams 140 that connect inner frame 130 to outer frame 120.

Referring to FIG. 4(C), etch-stop material 415 (e.g., boron) is then diffused into predefined regions 110(1) and 110(2) of substrate 110. In one embodiment, boron doping is performed by exposing substrate 110 to a boron source in a high temperature furnace. The boron diffuses through exposed portions 112(1) and 112(2) into predefined regions 110(1) and 110(2) to a depth and concentration dependent on furnace temperature and doping time. In one embodiment, diffusion is performed in a temperature range of 1000 to 1150° C. for a period of time in the range of 10 to 16 hours in order to fully diffuse boron into predefined regions 110(1) and 110(2) of substrate 110.

As shown in FIG. 4(D), after boron doping is completed, masking layer 410 is removed using known techniques.

While the above-described etch-stop diffusion process shows the formation of boron-based etch-stop regions 110(1) and 110(2) diffused into substrate 110, other techniques may also be used to provide the required etch-stop function. For example, boron may also be diffused into additional portions of upper surface 112 of substrate 110 in regions that correspond to outer frame 120 and inner frame 130 to aid the formation of flat surfaces 137 and 138 (see FIG. 1(A)). Further, an alternative process may be used in which a supplemental silicon layer having a thickness in the range of 1 to 10 μm is epitaxially deposited on substrate 110 and patterned to serve as etch-stop regions similar to the boron etch-stop regions described above. However, if epitaxial silicon is used, then portions of the epitaxial silicon located over the gaps 125, 127 and 128 (see FIGS. 1(C), 1(D) and 1(E)) will have to be removed after the anisotropic etching process.

2. Silicon Nitride Deposition

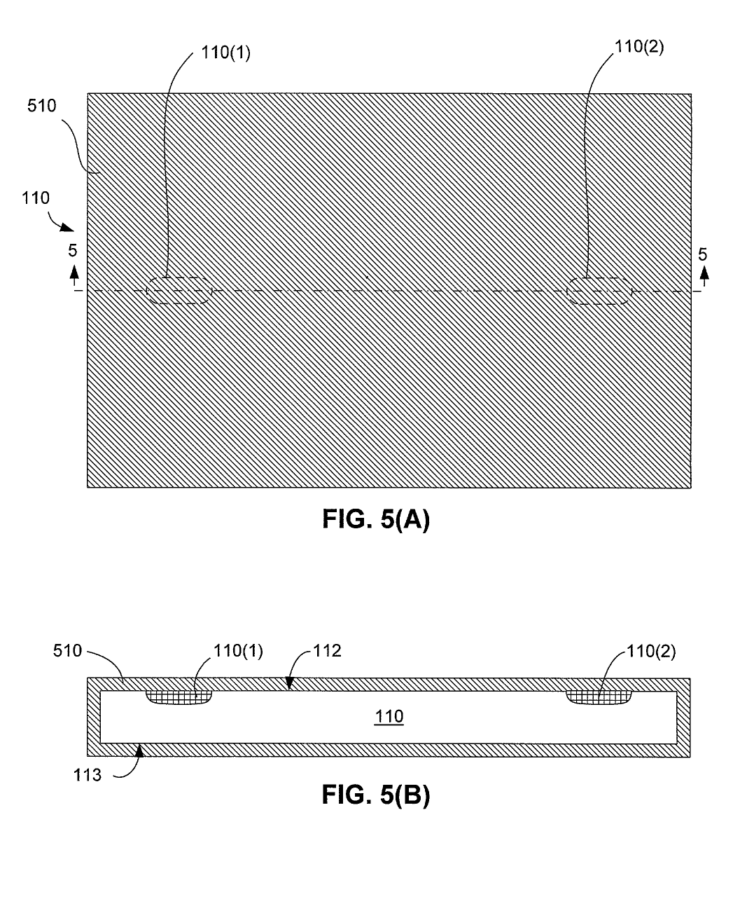

FIGS. 5(A) and 5(B) are plan and cross-sectional side views, respectively, showing the deposition of a silicon nitride layer 510 on all surfaces of substrate 110. In one embodiment, silicon nitride layer 510 is deposited using a pyrophoric reaction of two gases (i.e., dichlorosilane and ammonia) in a low-pressure tube at a temperature of approximately 700° C. The reaction produces a silicon-nitrogen compound (nominally Si₃N₄) that then forms a uniform, conformal coating on monocrystalline substrate 110. As indicated in FIG. 5(B), this silicon nitride coating (referred to as silicon nitride layer 510) is formed both on upper surface 112 (i.e., such that predefined regions 110(1) and 110(2) are entirely covered) and on lower surface 113 of substrate 110.

As discussed below, the main function of silicon nitride layer 510 is to act as a mask during the anisotropic etching process. As an optional second function, portions of silicon nitride layer 510 form part or all of beams 140 (see the examples shown in FIGS. 2(B) and 2(C), described above). When used as part of beam 140, silicon nitride layer 510 adds stress and stiffness to the underlying silicon due to the intrinsic tensile stress of silicon nitride. This added stress and stiffness helps to reduce stretching in beams 140 as inner frame 130 is pivoted relative to outer frame 120 (as depicted in FIG. 3).

3. Permalloy Formation

As discussed above, actuation of micromachined structure 100 (see FIG. 1(A)) in an opto-mechanical micro-switch arrangement requires the application of a driving force to inner frame 130 that causes pivoting or rotation of inner frame 130 relative to outer frame 120. In one embodiment, a magnetic material (i.e., Permalloy) is provided on inner frame 130 to allow magnetic actuation in response to a driving electromagnetic field. The driving electromagnetic field can be externally applied, mounted in close proximity to micromachined structure 100 on a hybrid substrate, or integrated onto micromachined structure 100. In other embodiments, the permalloy regions may be omitted and another actuating mechanism for pivoting or rotating inner frame 130 relative to outer frame 120 (as depicted in FIG. 3) can be used, such as mechanisms utilizing electrostatic, magnetic, or thermal energy.

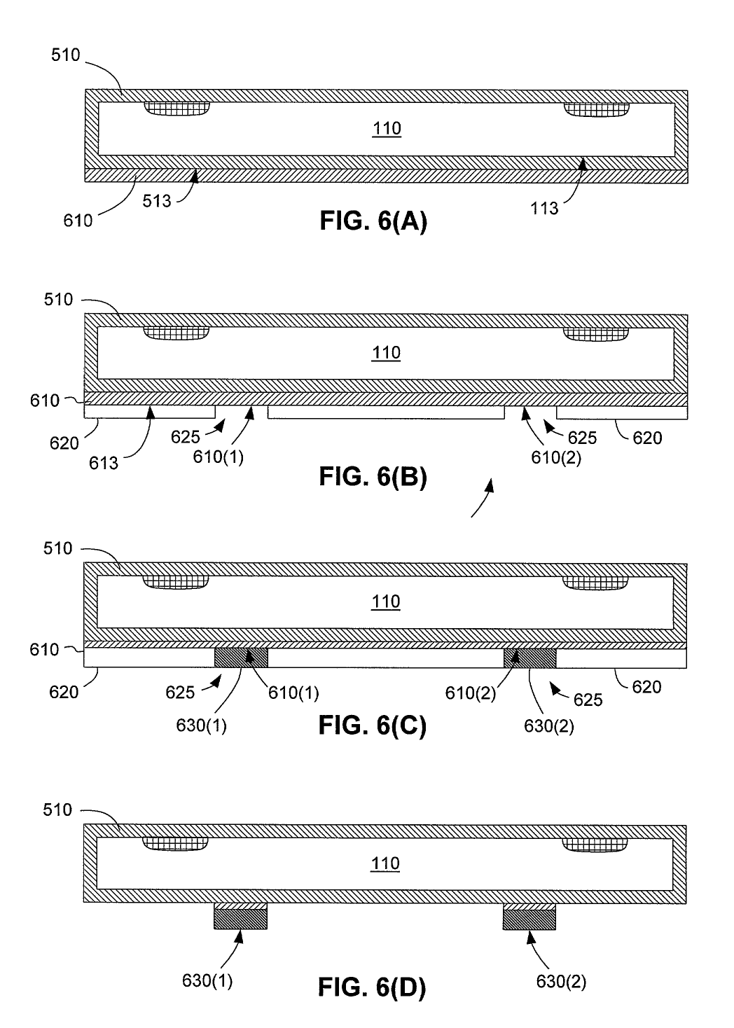

FIGS. 6(A) through 6(D) are sectional side views taken along line 5-5 in FIG. 5(A) that show process steps associated with the formation of permalloy regions on substrate 110.

Referring to FIG. 6(A), a seed layer 610 is deposited onto surface 513 of silicon nitride layer 510. Seed layer 610 is composed of a known metal (e.g., chrome and copper) that facilitates the electroplating of Permalloy.

FIG. 6(B) illustrates the subsequent deposition and patterning of a photoresist layer 620 on surface 613 of seed layer 610. Photoresist layer 620 is patterned to include windows 625 that expose regions 610(1) and 610(2) of seed layer 610. As discussed in additional detail below, exposed regions 610(1) and 610(2) are positioned adjacent to portions of substrate 110 corresponding to end pieces 132 of inner frame 130 (see FIG. 1(A)).

FIG. 6(C) shows the results of a Permalloy plating process during which Permalloy structures 630(1) and 630(2) are plated through windows 625 onto exposed seed layer regions 610(1) and 610(2) using know techniques. Note that Permalloy is not formed on photoresist layer 620. As mentioned above, permalloy structures 630(1) and 630(2) are located adjacent to portions of substrate 110 that correspond with end pieces 132 of inner frame 130 (see FIG. 1(A)).

FIG. 6(D) illustrates the subsequent step of stripping away photoresist layer 620 and portions of seed layer 610 (see FIG. 6(C) not covered by Permalloy structures 630(1) and 630(2). This stripping process is performed using known methods.

The Permalloy plating process described above is one of several possible methods for forming magnetic material structures used in magnetic actuation of micromachined structure 100. Actuation structures using other magnetic materials may also be formed using known methods. In addition, non-magnetic actuation structures may be utilized in place of Permalloy structures 630(1) and 630(2).

4. Anisotropic Etching

Referring briefly to FIG. 1(A), outer frame 120 is separated from inner frame 130 by selectively-formed gaps 125, 127 and 128. In accordance with an important aspect of the present invention, these gaps are formed using an anisotropic etching process that produces flat surfaces 137 and 138 on wall 135 of inner frame 130. When formed by anisotropic etching, flat surfaces 137 and 138 intersect parallel upper and lower surfaces 112 and 113 at a slanted (non-perpendicular) angle. In the present embodiment in which substrate 110 is monocrystalline silicon, the anisotropic etching process forms flat surfaces 137 and 138 along {111} planes of the monocrystalline silicon. In particular, the etch rate of the anisotropic etchant depends on the crystallographic orientation of the exposed silicon surface. The {100} surface of the silicon wafer etches at a much faster rate than the {111} crystal plane, which intersects the {100} surface at an angle of 54.7 degrees. Thus, as the silicon etch progresses, the etched wells become bounded by these {111} planes. As described above with reference to FIG. 3, by forming flat surfaces 137 and 138 at a slanted angle, these surfaces are rotated into a perpendicular position when inner frame 130 is pivoted relative to outer frame 120 around beams 140.

In accordance with another aspect of the present invention, the anisotropic etching process is performed simultaneously on both sides of substrate 110 (i.e., such that etchant is applied simultaneously to upper surface 112 and lower surface 113. By simultaneously etching from both sides of substrate 110 in the manner set forth below, a thin slab of silicon is formed between opposing {111} etch planes that form walls 135 of inner frame 130 (see FIG. 1(A)). Further, the inward-facing surface 137 and outward-facing surface 138 (see FIG. 1(B)), which must be flat (planar) in some embodiments to provide reliable mirror surfaces on wall 135, are reliably formed by these opposing {111} etch planes.

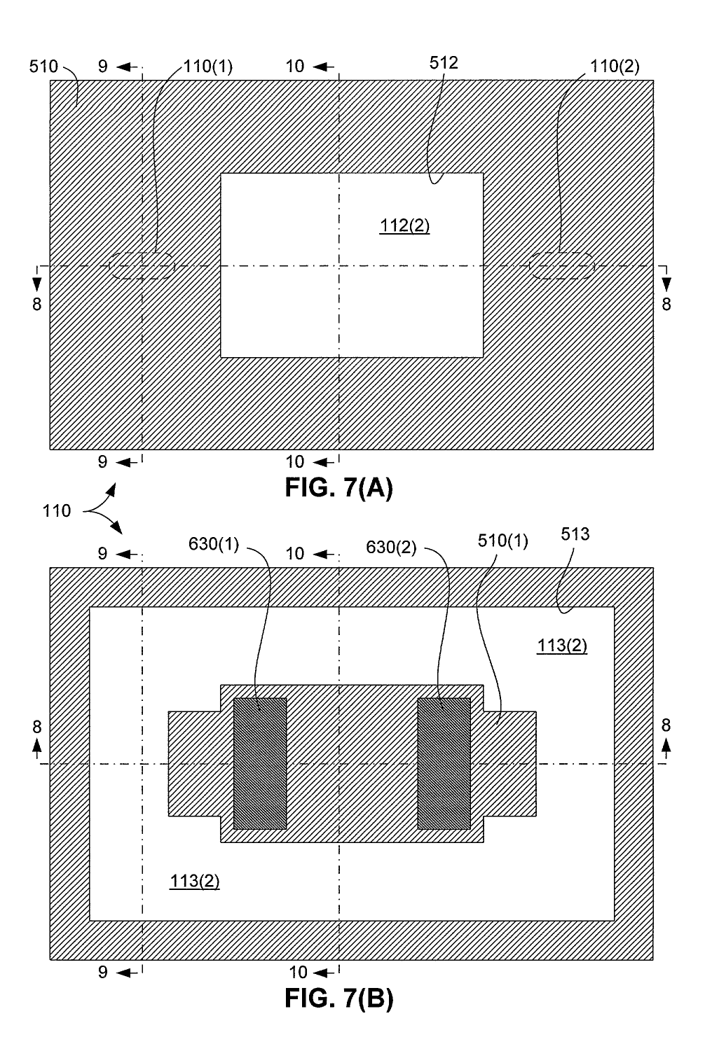

The anisotropic etching process in accordance with an embodiment of the present invention is described with reference to FIGS. 7(A) through 10(B).

FIG. 7(A) is a plan top view and FIG. 7(B) is a bottom plan view showing substrate 110 after silicon nitride layer 510 is patterned to form a mask that is used during the anisotropic etching process. Specifically, silicon nitride layer 510 is photolithographically patterned and then etched, for example, using a plasma etch process, to form windows exposing selected portions of substrate 110. The photoresist used during the plasma etch process is then removed.

Referring to FIG. 7(A), a rectangular window 512 is formed on upper surface 112 to expose a surface portion 112(2). Rectangular window 512 has a length (measured along line 8-8) of approximately 2100 μm, and a width (measured along line 9-9) of approximately 2000 μm. Note in FIG. 7(A) that portions of silicon nitride layer 510 located over etch-stop diffusion regions 110(1) and 110(2) remain intact.

Referring to FIG. 7(B), a second window 513 is formed on lower surface 113 to expose a ring-shaped portion 113(2) surrounding a central portion 510(1) of silicon nitride layer 510. Permalloy structures 630-1 and 630-2 are located within the outer boundaries of central portion 510(1). In one embodiment, exposed peripheral surface portion 113(2) has a width of approximately 2900 μm, and central portion 510(1) has length (measured along line 8-8) of approximately 3600 μm, and a width (measured perpendicular to line 9-9) of approximately 1400 μm. Well-known corner compensation features (not shown) are utilized to preserve convex corners of substrate 110 during the anisotropic etching process.

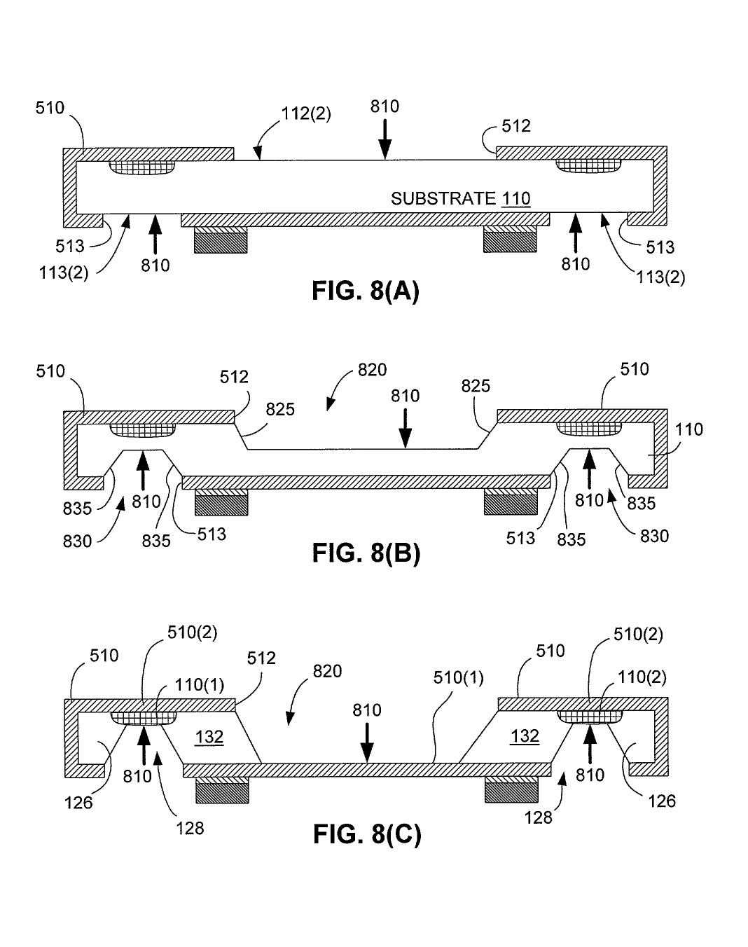

After silicon nitride layer 510 is patterned to form a mask, anisotropic etchant is applied simultaneously to both upper surface 112 and lower surface 113 of substrate 110. FIGS. 8(A) through 8(C), 9(A) through 9(C), and 10(A) through 10(C) illustrate this anisotropic etching process from various cross-sections of substrate 110. In particular, FIGS. 8(A) through 8(C), 9(A) through 9(C), and 10(A) through 10(C) are cross-sectional views taken along lines 8-8, 9-9 and 10-10, respectively, that are shown in FIGS. 7(A) and 7(B).

Referring to FIG. 8(A), substrate 110 is exposed to an anisotropic etchant 810 (e.g., an aqueous potassium hydroxide (KOH) solution). Anisotropic etchant 810 simultaneously etches both exposed upper surface portion 112(2) through window 512 in silicon nitride layer 510, and exposed lower surface portion 113(2) through window 513. As mentioned above, silicon nitride layer 510 acts as a mask that prevents etching in non-exposed regions of substrate 110.

FIG. 8(B) shows an intermediate stage of the etching process in which etchant 810 has advanced partially through substrate 110. Through window 512, etchant 810 forms a first well 820 having flat surfaces 825. As mentioned above, the etch rate of the anisotropic etchant depends on the crystallographic orientation of monocrystalline silicon substrate 110. The {100} surface of the silicon wafer etches at a much faster rate than the {111} crystal plane, which intersects the {100} surface at an angle of 54.7 degrees. Thus, as the silicon etch progresses, etched well 820 become bounded by surfaces 825 that are defined by these {111} planes. Similarly, through window 513, etchant 810 forms a second well 830 bounded by surfaces 835 that are defined by {111} planes of monocrystalline silicon substrate 110.

FIG. 8(C) shows a final stage of the etching process in which wells 820 and 830 extend entirely through substrate 110. For example, well 820 is bounded by flat walls 825 that extend from the edge of window 512 to an upper surface of silicon nitride layer portion 510(1). Similarly, well 830 is bounded by flat walls 835 that extend from the edge of window 513 to a lower surface of silicon nitride layer portions 510(2). Note that the etch-stop material located in predefined regions 110(1) and 110(2) prevents etching in these regions, thereby forming a section of monocrystalline silicon substrate 110 that extends between end pieces 132 of inner frame 130 and end rails 126 of outer frame 120 (see FIG. 1(A)).

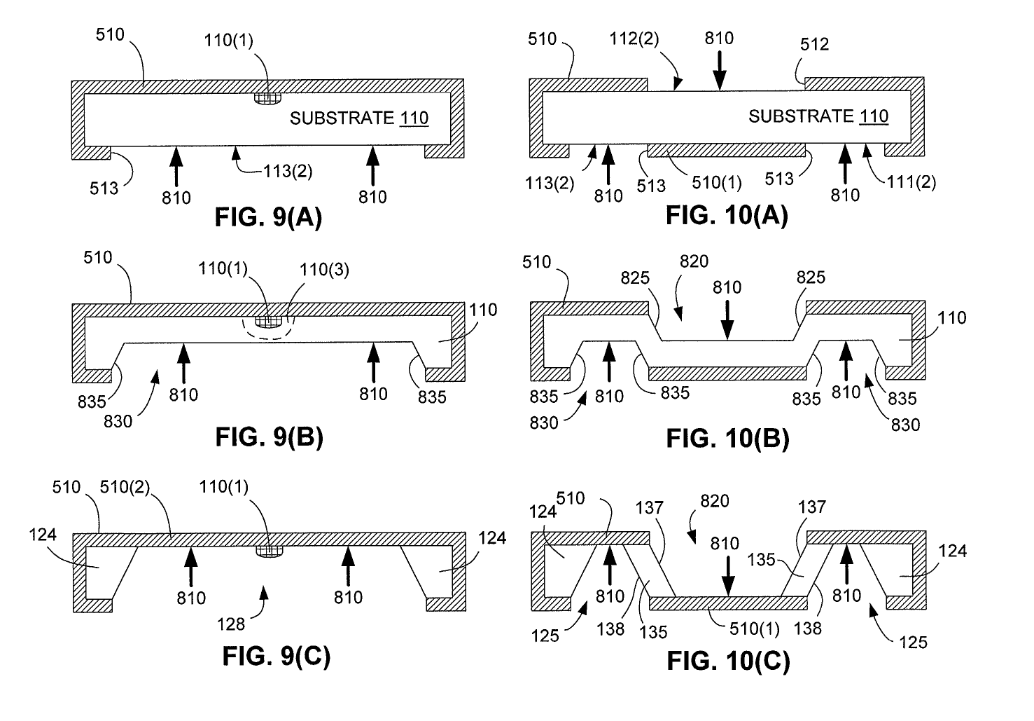

FIGS. 9(A) through 9(C) illustrate the anisotropic etching process as viewed along line 9-9 of FIGS. 7(A) and 7(B). In particular, FIGS. 9(A) through 9(C) show the formation of gap 128 between outer frame 120 and inner frame 130 (see FIG. 1(A)). Referring to FIG. 9(A), when substrate 110 is exposed to anisotropic etchant 810, etching proceeds through window 513 on exposed lower surface portion 113(2). FIG. 9(B) shows an intermediate stage in which etchant 810 has formed second well 830 bounded by flat surfaces 835. Note undoped region 110(3) located adjacent to etch-stop diffusion region 110(1). Referring to FIG. 9(C), undoped regions 110(3) are entirely etched away during the final stages of the etching process, thereby leaving a section of monocrystalline silicon substrate 110 that forms a portion of beams 140 (see FIG. 1(A)). Etch-stop diffusion region 110(2) (see FIG. 8(C)) is similarly separated from substrate 110, and is aligned with diffusion region 110(1) to define an axis of rotation around which inner frame 130 rotates (pivots) relative to the outer frame 120.

FIGS. 10(A) through 10(C) illustrate the anisotropic etching process as viewed along line 10-10 of FIGS. 7(A) and 7(B). In particular, FIGS. 10(A) through 10(C) show the formation of walls 135 located on inner frame 130 (see FIG. 1(A)). Referring to FIG. 10(A), when substrate 110 is exposed to anisotropic etchant 810, etching simultaneously occurs both on exposed upper surface portion 112(2) through window 512, and on exposed lower surface portion 113(2) through window 513. FIG. 10(B) shows an intermediate stage in which etchant 810 has formed first well 820 bound by flat surfaces 825, and second well 830 bounded by flat surfaces 835. As mentioned above, flat surfaces 825 and 835 are defined by {111} planes of monocrystalline silicon substrate 110. Finally, FIG. 10(C) shows a final stage of the etching process in which etchant 810 has etched entirely through substrate 110, thereby exposing the upper surface of silicon nitride portion 510(1) and forming gaps 125 that are located between side rails 124 of outer frame 120 and walls 135 of inner frame 130. Note that simultaneously etching both sides of substrate 110 produces parallel flat surfaces 137 and 138 of walls 135.

After anisotropic etching is completed an optional polishing etch step may be used to provide inward-facing surface 137 and outward-facing surface 138 of wall 135 (see FIG. 10(C) with mirror-smooth finishes. The smoothness of inward-facing surface 137 and outward-facing surface 138 is critical when these surfaces are used as mirrors (i.e., when low light loss is required). In order to reduce the roughness of these surfaces, an additional etchant (e.g., a solution of hydrofluoric acid) may be applied to polish these (111) mirror surfaces.

5. Frame Separation

As indicated in FIGS. 8(C), 9(C) and 10(C), portions of silicon nitride 510 remain connected over gaps 125, 127 and 128 between outer frame 120 and inner frame 130 at the completion of the anisotropic etching process. These portions of silicon nitride 510 must be removed to allow pivoting of inner frame 130 relative to outer frame 120. In embodiments where silicon nitride layer 510 is not utilized as part of micromachined structure 100 (e.g., see the embodiment shown in FIG. 2(A)), the frame separation process is performed simply by removing silicon nitride layer 510 using, for example, a short plasma etch. However, in embodiments in which portions of silicon nitride layer 510 are utilized as epitaxial structures of micromachined structure 100 (e.g., see the embodiments shown in FIGS. 2(B) and 2(C)), then selective plasma etching may be performed using a mask that exposes unwanted silicon nitride regions (e.g., portion 510(1), see FIGS. 8(C) and 9(C)). Such techniques are well known.

6. Metallization

An optional metallization process is performed when mirror surfaces are required on walls 135. After the etch-stop regions of substrate 110 are etched to separate inner frame 130 from outer frame 120, inward-facing surfaces 137 and/or outward-facing surfaces 138 are coated with either partially or totally reflecting materials (e.g., metal or dielectric), depending on the application. The coatings can be applied using evaporation, sputtering, or CVD processes. Such metallization is either applied to all surfaces of micromachined structure 100, or applied to surfaces 137 and 138 using a physical shadow mask according to known techniques.

Although the invention has been described in connection with several embodiments, it is understood that this invention is not limited to the embodiments disclosed, but is capable of various modifications which would be apparent to a person skilled in the art. Thus, the invention is limited only by the following claims.

What is claimed is:

1. A micromachined structure comprising:
an outer frame having an upper surface defining a first plane; and
an inner frame surrounded by and pivotally connected to the outer frame, the inner frame including a wall having a flat surface defining a second plane that intersects the first plane;
wherein the outer frame and the inner frame are formed from a single substrate.

2. The micromachined structure according to claim 1, wherein the substrate is a single silicon crystal, wherein the first plane is a {100} plane of the single silicon crystal, and wherein the second plane is a {111} plane of the single silicon crystal.

3. The micromachined structure according to claim 1, further comprising first and second beams extending between the outer frame and the inner frame.

4. The micromachined structure according to claim 3, wherein the first and second beams comprise portions of the substrate connected between the outer frame and the inner frame.

5. The micromachined structure according to claim 4, wherein the first and second beams further comprise material deposited on the upper surface.

6. The micromachined structure according to claim 5, wherein the material deposited on the upper surface comprises silicon nitride.

7. The micromachined structure according to claim 3, wherein the first and second beams comprise a material formed on the upper surface.

8. The micromachined structure according to claim 7, wherein the material formed on the upper surface comprises silicon nitride.

9. The micromachined structure according to claim 1, wherein the flat surface includes a light reflecting material formed thereon.

10. The micromachined structure according to claim 1, wherein the second plane intersects the first plane at an angle of 54.7°.

11. The micromachined structure according to claim 1, wherein the inner frame is pivotable from a first position in which the second plane intersects the first plane at an acute first angle, to a second position in which the second plane intersects the first plane at a second angle of 90°.

12. The micromachined structure according to claim 1, wherein the inner frame comprises a pair of end pieces and a pair of walls that extend between the end pieces and define a center hole.

13. The micromachined structure according to claim 12, further comprising Permalloy portions formed on the end pieces of the inner frame.

14. A opto-mechanical micro-switch comprising:
a light source;
a light receiver; and
a micromachined structure connected to the light source and the light receiver, the micromachined structure including:
an outer frame having an upper surface defining a first plane; and
an inner frame surrounded by and pivotally connected to the outer frame, the inner frame including a wall having a flat surface defining a second plane that intersects the first plane;
wherein the outer frame and the inner frame are formed from a single substrate.

15. The opto-mechanical micro-switch according to claim 14, further comprising a drive motor including Permalloy regions formed on the inner frame.

16. A micromachined structure entirely formed from a monocrystalline silicon substrate, the micromachined structure comprising:
an outer frame;
an inner frame surrounded by the outer frame and separated from the outer frame; and
first and second beams connected between the inner frame and the outer frame;
wherein the first and second beams are aligned along an axis of rotation about which the inner frame is pivotable relative to the outer frame.

17. The micromachined structure according to claim 16, wherein the first and second beams comprise portions of the monocrystalline silicon substrate into which is diffused an etch-stop material.

18. The micromachined structure according to claim 17, wherein the etch-stop material is boron.

19. A opto-mechanical micro-switch comprising:
a light source;
a light receiver; and
a micromachined structure entirely formed from a monocrystalline silicon substrate, the micromachined structure including:
an outer frame connected to the light source and the light receiver;
an inner frame surrounded by the outer frame and separated from the outer frame; and
first and second beams connected between the inner frame and the outer frame;
wherein the first and second beams are aligned along an axis of rotation about which the inner frame is pivotable relative to the outer frame.

20. The opto-mechanical micro-switch according to claim 19, further comprising a drive motor including Permalloy regions formed on the inner frame.

21. A method for fabricating a micromachined structure comprising:
diffusing etch-stop material into first predefined regions in a monocrystalline silicon substrate; and
etching second predefined regions of the monocrystalline silicon substrate to form an inner frame surrounded by an outer frame,
wherein the second predefined regions are located adjacent to the first predefined regions such that, after the etching step, the first predefined regions form beams that are aligned along an axis of rotation and connect the inner frame to the outer frame.

22. The method according to claim 21, wherein the step of diffusing etch-stop material comprises:
depositing a mask material onto an upper surface of the monocrystalline silicon substrate;
patterning the mask material to define openings located over the first predefined regions of the monocrystalline silicon substrate;
diffusing boron through the openings into the first predefined regions; and
removing the mask material from the monocrystalline silicon substrate.

23. The method according to claim 21,
wherein the monocrystalline silicon substrate includes upper and lower surfaces defined by {100} planes of the monocrystalline silicon substrate; and
wherein the step of etching comprises:
depositing a mask material onto the upper and lower surfaces;
patterning the mask material to define openings that expose portions of the upper and lower surfaces located adjacent to the second predefined regions of the monocrystalline silicon substrate;
applying an anisotropic etchant to the exposed portions of the upper and lower surfaces, thereby forming a wall of the inner frame that includes a flat surface defining a {111} plane of the monocrystalline silicon substrate.

24. The method according to claim 23, wherein the step of depositing the mask material comprises depositing silicon nitride.

25. The method according to claim 23, wherein the step of applying an anisotropic etchant comprises applying an aqueous potassium hydroxide solution simultaneously to the upper and lower surfaces of the monocrystalline silicon substrate.

26. The method according to claim 23, further comprising the step of forming permalloy regions on the monocrystalline silicon substrate before patterning the mask material.

27. A method for fabricating a micromachined structure from a monocrystalline silicon substrate, wherein the monocrystalline silicon substrate includes upper and lower surfaces defined by {100} planes of the monocrystalline silicon substrate, wherein the method comprises:
depositing a mask material onto the upper and lower surfaces;
patterning the mask material to define openings that expose portions of the upper and lower surfaces located adjacent to predefined regions of the monocrystalline silicon substrate; and
applying an anisotropic etchant to the exposed portions of the upper and lower surfaces, thereby forming a wall of the inner frame that includes a flat surface defining a {111} plane of the monocrystalline silicon substrate.

28. The method according to claim 27, wherein the step of depositing the mask material comprises depositing silicon nitride.

29. The method according to claim 27, wherein the anisotropic etchant comprises an aqueous potassium hydroxide solution.

30. The method according to claim 27, further comprising the step of applying a reflective material to the flat surface of the wall.
